(19) United States
(12) Patent Application Publication
(10) Pub. No.: US 2015/0134661 A1
(43) Pub. Date: May 14, 2015

(54) Multi-Source Media Aggregation

(71) Applicant: Apple Inc., Cupertino, CA (US)

(72) Inventors: Eric Circlaeys, Paris (FR); Kjell Bronder, San Francisco, CA (US); Ralf Weber, San Jose, CA (US)

(73) Assignee: Apple Inc., Cupertino, CA (US)

(21) Appl. No.: 14/080,553

(22) Filed: Nov. 14, 2013

(51) Int. Cl. G06F 17/30

(52) U.S. Cl. CPC G06F 17/30598; G06F 17/30424; G06F 17/30053
USPC 707/737; 707/752

(57) ABSTRACT

A user interface to match a requested set of media items for display in a media item arrangement requires an efficient method of obtaining properties of the requested media items. The requested media items may span across multiple connected sources and be associated with multiple users. A first cache layer of a multi-layer cache system stores a flat representation of metadata items corresponding to media items available from connected sources. A second cache layer stores compiles metadata items from the first cache layer into sets of metadata items for various media item groupings. A third cache layer compiles sets of metadata items from the second cache layer into ordered sets of metadata items. The ordered sets of metadata items may be used to identify an appropriate media item arrangement in which to display the associated media items.

### BACKGROUND

This disclosure relates generally to techniques to display a group of media items in an optimal media arrangement. More particularly, the disclosure relates to techniques to efficiently retrieve and store media item properties such that the optimal media item arrangement for a given set of media items may be determined efficiently.

With the rapid increase in the number of devices capable of capturing digital media and the number of repositories for such media, there exists a need for an interface that is capable of aggregating, sorting, and displaying all of the media to which a user has access in a visually pleasing manner. Because media items may be stored on various sources (e.g., local device storage, remote social networking services, remote storage services, etc.), a user interface must be able to abstract the differences between the sources (e.g., latencies, response times, etc.) in order to present the media items to the user in a consistent manner. In addition, because many of the devices capable of capturing and displaying such media have relatively limited memory and processing capabilities (e.g., mobile devices such as phones, tablets, and PDAs), the user interface must be capable of efficiently storing and retrieving media items and information about the media items such that user-selected items can be displayed in a manner that improves the user experience.

### SUMMARY

A method to fit a set of media items to a media item arrangement may begin with a request to display the media items (i.e., a media request). In response to receiving the request, it may be determined whether an ordered set of metadata items corresponding to the request is stored in a high level cache layer in persistent storage. If it is determined that the ordered set of metadata items is stored in the high level cache layer, the ordered set of metadata items may be retrieved. If the ordered set of metadata items is not stored in the high level cache layer, the ordered set of metadata items may be constructed from other metadata items in one or more lower level cache layers in persistent storage. Constructing the ordered set of metadata items may include determining whether a set of metadata items for each of one or more media item groupings corresponding to the request is stored in a second lower level cache layer, and, if not, constructing the set of metadata items for the media item grouping from metadata items stored in a first lower level cache layer. The retrieved or constructed ordered set of metadata items may be utilized to identify a media arrangement in which to display one or more media items corresponding to the request. The method may be embodied in program code and stored on a non-transitory medium. The stored program code may be executed by one or more processors that are part of, or control, a system that is configured to implement the method.

### BRIEF DESCRIPTION OF THE DRAWINGS

FIG. 1 illustrates the aggregation of media items from multiple media sources for display in a media arrangement in accordance with one embodiment.

FIG. 2 illustrates a flowchart for a cache update operation in accordance with one embodiment.

FIG. 3 is a block diagram that illustrates the structure of a first cache layer in accordance with one embodiment.

FIG. 4 is a block diagram that illustrates the abstraction of different media groupings for various sources in accordance with one embodiment.

FIG. 5 illustrates a persistent disk cache containing multiple cache layers in accordance with one embodiment.

FIG. 6 illustrates a flowchart for a metadata retrieval operation to fit media items in a media arrangement in accordance with one embodiment.

FIG. 7 is a block diagram that illustrates the different metadata cache states of various group paths associated with a single media request in accordance with one embodiment.

FIG. 8 is a block diagram that illustrates an architecture for retrieving and utilizing cached metadata in accordance with one embodiment.

FIG. 9 shows an illustrative electronic device in accordance with one embodiment.

### DETAILED DESCRIPTION

This disclosure pertains to systems, methods, and computer readable media for displaying user-selected media items in a manner that enhances the user experience. In general, a set of media items may be matched to, and displayed in accordance with, one of a number of predefined media arrangements as described in the co-pending applications entitled “Semi-Automatic Organic Layout for Media Streams” and “Viewable Frame identification”, both of which are being filed concurrently with this application and the contents of which are incorporated herein by reference. Because matching a set of media items to a media arrangement is dependent, at least in part, upon the properties of media items in the set, it is beneficial that the media item properties be obtained quickly in order to avoid a time lag between a user's request and the display of media items. Long lag times negatively impact the user experience. In one embodiment of the disclosure, a multi-layer cache system may be configured to maintain media item metadata for different media item groupings so as to enable quick retrieval of the information necessary to display media items in an optimal arrangement.

In the following description, for purposes of explanation, numerous specific details are set forth in order to provide a thorough understanding of the inventive concept. As part of this description, some of this disclosure's drawings represent structures and devices in block diagram form in order to avoid obscuring the invention. In the interest of clarity, not all features of an actual implementation are described in this specification. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

It will be appreciated that in the development of any actual implementation (as in any development project), numerous decisions must be made to achieve the developers' specific goals (e.g., compliance with system- and business-related constraints), and that these goals will vary from one implementation to another. It will also be appreciated that such development efforts might be complex and time-consuming, but would nevertheless be a routine undertaking for those of ordinary skill in the art of data processing having the benefit of this disclosure.

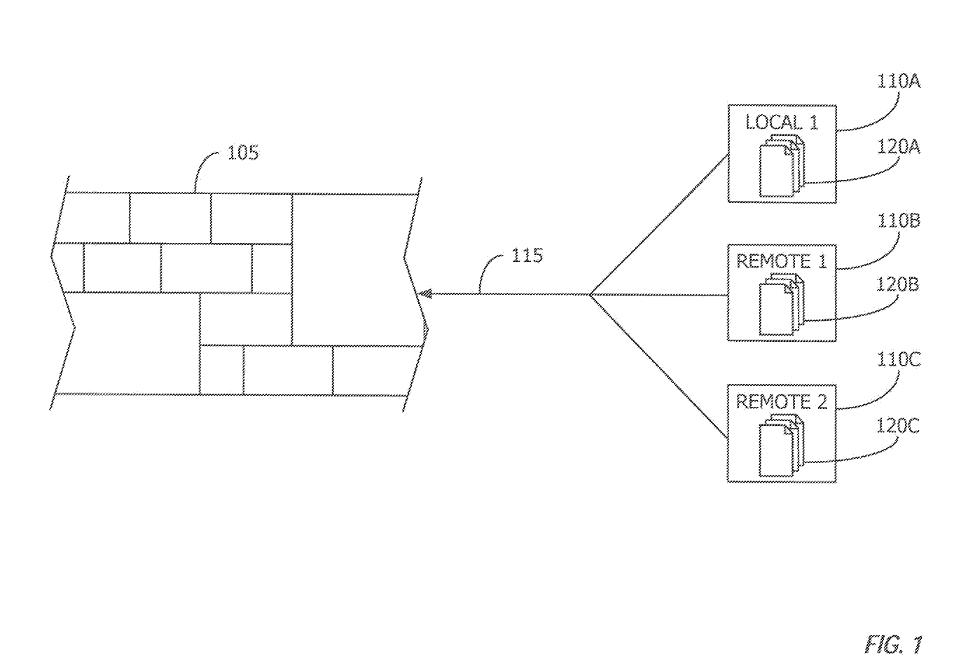

Referring to FIG. 1, an optimal media arrangement 105 to display a stream of media items 115 may be selected from a set of predefined media arrangements. The media items in stream 115 may include items available from one or more local sources (e.g., a local image editing application, a local image library, etc.) and/or one or more remote sources (e.g., a social networking service, a remote storage service, a remote image editing service, etc.). In the illustrated embodiment, a user request to display media items may result in the determination of optimal media arrangement 105 to accommodate media items from first local source 110A, first remote source 1108, and second remote source 110C. By way of example, a user may submit a request to view all of the media items associated with a particular individual (e.g., the user's own media items or the media items of another individual to which the user has access) or may provide specific criteria for desired media items (e.g., media items for one or more individuals and from a set of sources). Based on the user's request, each of the relevant sources may be queried to determine whether any media items satisfying the request are available. The request may result in the determination that media items 120A from source 110A, media items 120B from source 1108, and media items 120C from source 110C all satisfy the criteria identified in the request.

As described in copending Application entitled “Semi-Automatic Organic Layout for Media Streams”, the determination of optimal media arrangement 105 involves the ordering of the media items (e.g., media items 120A, 120B, and 120C) in a media stream (e.g., stream 115) and the evaluation of the properties of the ordered media items against the properties of a set of predefined media arrangements to identify the most appropriate media arrangement (e.g., media arrangement 105). It will be understood that in order to match a set of media items to an appropriate media arrangement in a manner that improves the user experience (e.g., presents media items from different sources without undue delay), it is necessary to quickly retrieve the needed properties of the media items in a media set and to abstract the differences between the sources from which the media items and their corresponding properties are retrieved.

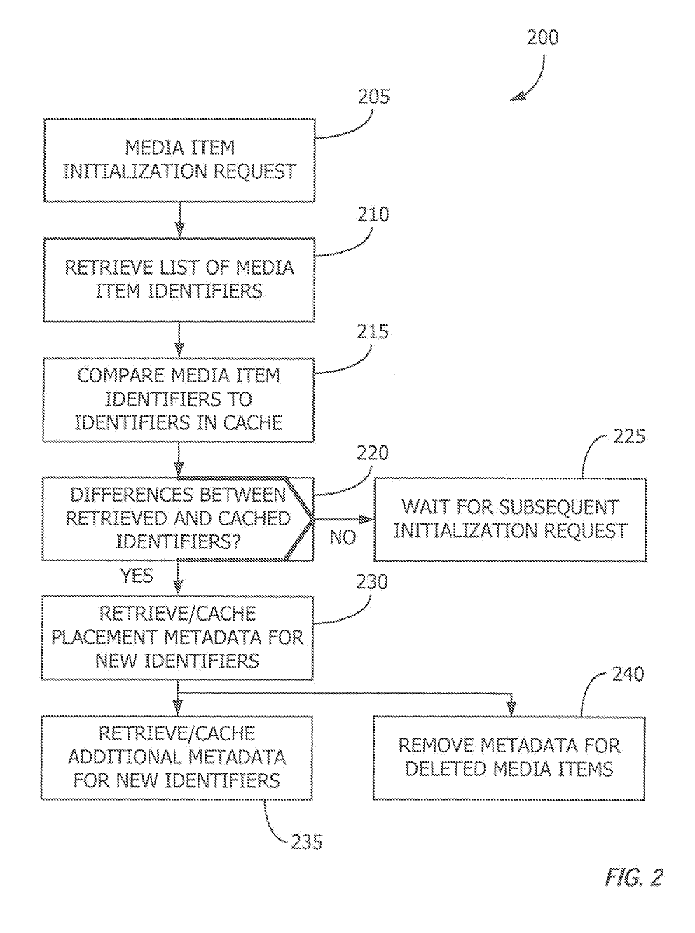

Referring to FIG. 2, cache update operation 200 may begin with a media item initialization request (block 205). The media item initialization request may be initiated at any time that it may be desirable to retrieve a current list of media items available from connected sources. In one embodiment, the media item initialization request may be initiated upon launching an application that provides for media item arrangement in accordance with one or more embodiments of this disclosure. In another embodiment, the media item initialization request may be initiated according to a predefined frequency while such an application is executing. For example, it may be desirable to determine the availability of any newly added media items from one or more local sources and/or one or more remote sources every 15 minutes while such an application is executing. In yet another embodiment, a media item initialization request may be initiated on demand. For example, the most currently available media items may be determined when a request to display or otherwise interact with media items is received.

In response to the media item initialization request, a list of media item identifiers representing all of the available media items from connected sources may be retrieved (block 210). As described above with respect to FIG. 1, a media arrangement may include media items from multiple local sources and multiple remote sources. In response to a media item initialization request, an application may query each of the connected sources (or the relevant sources based on the initialization request) for a list of media item identifiers corresponding to the request. For example, the application may request a list of media item identifiers from a local image library that executes on the same device or intranet as the application. Similarly, the application may request a list of media item identifiers from a remote (e.g., server-side) social networking application via a network connection between the remote source and the device on which the application is executing. By way of example, the application may utilize the user's login credentials for a social networking service to obtain a list of media item identifiers corresponding to media items shared via the social networking application by the user and social network “friends” of the user. In one embodiment, this initial query to obtain identifiers may be executed as a batch query having the smallest possible payload for each particular source.

Each media item identifier may be globally unique within its respective source. That is, an identifier for a media item available from a first source may uniquely identify that particular media item within the first source. In one embodiment, the media item identifier for a media item may be a hash value of all or some predefined portion of the data representing the media item. In another embodiment, the media item identifier may be a value assigned to the media item at the time the media item is provided to the source. While each media item identifier may uniquely identify a corresponding media item within a particular source, it is possible that the media item identifier is not unique across the multiple sources connected to the application for providing the media arrangement. Therefore, in one embodiment, a media item identifier within the application may be formed from a source media item identifier and a unique source identifier. For example, media items within the application may be uniquely identified by a concatenation of a source identifier and the retrieved media item identifier from the source.

Each media item may also be associated with a user. As used herein, a media item is associated with a user if the user is the “owner” of the media item. For example, if a media item is uploaded to a social networking service by a first user to the first user's account, the media item is associated with the first user even though it may be viewed by a second user (e.g., a social network friend of the first user). Similarly, if the second user were to retrieve a copy of the same media item and upload the media item to their social network account (or local library, remote image editing account, etc.), that copy of the media item would be associated with the second user. Likewise, a media item stored in a local source (e.g., a local image library that executes on the same device as the media arrangement application) may be associated with the user of the local image library (e.g., the user of the device on which the local image library executes). If the local image library allows for the segregation of images by different user accounts, then an image would be associated with the user of the account with which the image is associated.

It will be understood that the retrieval of media items may differ by source. For example, the retrieval APIs provided by each source may utilize different arguments, variables, etc. In addition, media item groupings may differ by source. For example, a social networking source may group media items by user and album (e.g., a user may have multiple social network “friends” each having one or more media item albums) while a local photo library may group media items by album alone. In order to maintain these native groupings and to present media items from multiple sources consistently, media arrangement operation 200 may employ a modular architecture that abstracts these differences and allows the application to interact with the various sources without the need to implement special routines for each source. In one embodiment, the retrieval of data may be performed using an independent thread per source.

After the media item identifiers are retrieved, the identifiers may be compared to cached media item identifiers (block 215). As will be described in greater detail below, in one embodiment a persistent cache stores media item identifiers and corresponding metadata to enable a user-selected group of media items to be matched with an appropriate media arrangement with the minimal number of interactions with each source. This persistent cache may be described as a first cache layer and may be maintained as a flat set of media item identifiers and associated metadata that may be segmented per source and per user.

Based on the comparison, it may be determined if any differences exist between the cached media item identifiers and the retrieved media item identifiers (block 220). It will be recognized that the differences between the retrieved media item identifiers and the cached media item identifiers represent changes in available media items between media item initialization requests. For example, media item identifiers that are present in the cache but not in the list of retrieved media item identifiers may represent media items that have been deleted from a particular source since a last initialization request. Likewise, media item identifiers that are present in the list of retrieved media item identifiers but not in the cached media item identifiers may represent media items that have been added to a particular source since a last initialization request.

If it is determined that no differences exist between the retrieved and cached media item identifiers (the “No” prong of block 220), no cache updates are necessary and cache update operation 200 waits for a subsequent media item initialization request (block 225). If, however, differences between the retrieved and cached media item identifiers are detected (the “Yes” prong of block 220), placement metadata may be retrieved from the appropriate sources for the new media items (i.e., corresponding to the retrieved media item identifiers not having a matching cache identifier) and added to the cache (block 230). Because one goal of cache update operation 200 is to quickly update a first cache layer with information necessary to place media items within a media item arrangement, cache update operation 200 provides for the retrieval of placement metadata prior to any other metadata. As used herein, placement metadata refers to media item properties that are important in determining the placement of media items within a media item arrangement. In one embodiment, the placement metadata may include the media item type (e.g., image, video, audio, text, etc.) and the media item aspect ratio. The placement metadata may additionally include data such as media item creation date or importance information, each of which may be used to order individual media items within a set of media items. Placement data can enable media items to be ordered within a set of media items and compared with predefined media arrangements to determine an appropriate media arrangement for displaying the set of media items.

The placement metadata may be retrieved by querying the appropriate source(s) using the media item identifiers corresponding to the added media items. In one embodiment, the query may be structured as a batch query to obtain the desired placement metadata values for each of the added media item identifiers. Using a batch query may be advantageous as it may offer more efficient and faster access to stored data and may also allow for more efficient data transfer and thus cut down on the total volume of data required to query the requested information. This is because there generally is a considerable amount of overhead for formulating and packaging individual queries and when queries are batched together, a lot of that overhead is eliminated on a per-query cost basis. In one embodiment, use of batch queries may not be possible, when the source does not support batch queries. In another embodiment, batch queries may be limited to a certain amount which may require that each batch query be paged in multiple batch queries. As an alternative to batch queries, it is possible to store a time stamp or another type of query identification or hash for a query and then ask for all changes since the time stamp or other query identification at the next query. In one embodiment, the queries for different sources may be executed in separate threads.

After the placement metadata has been retrieved for the added media items, additional metadata may be retrieved (block 235). The additional metadata may include properties associated with the added media items such as resolution, duration, geolocation, size, caption, comments, ratings, and region of interest data. As will be described in greater detail below, this additional metadata may enable filters and clusters to be applied to a set of media items to refine the displayed results in accordance with desired properties. In a similar manner to the retrieval of placement metadata, the additional metadata may be retrieved by querying appropriate sources using the media item identifiers for the added media items. In addition, the retrieval of certain additional metadata may be performed by generating the metadata locally. For example, metadata to identify regions of interest within an image that contain faces may be obtained by retrieving a copy of the media item (e.g., a reduced quality thumbnail copy) and performing face recognition locally. In addition to retrieving the additional metadata for the added media items, metadata may be removed from the first cache layer for deleted media items (block 240). It will be noted that the retrieval of the additional metadata and the removal of metadata from the cache for deleted media items are generally assigned a lower priority than the retrieval of placement metadata.

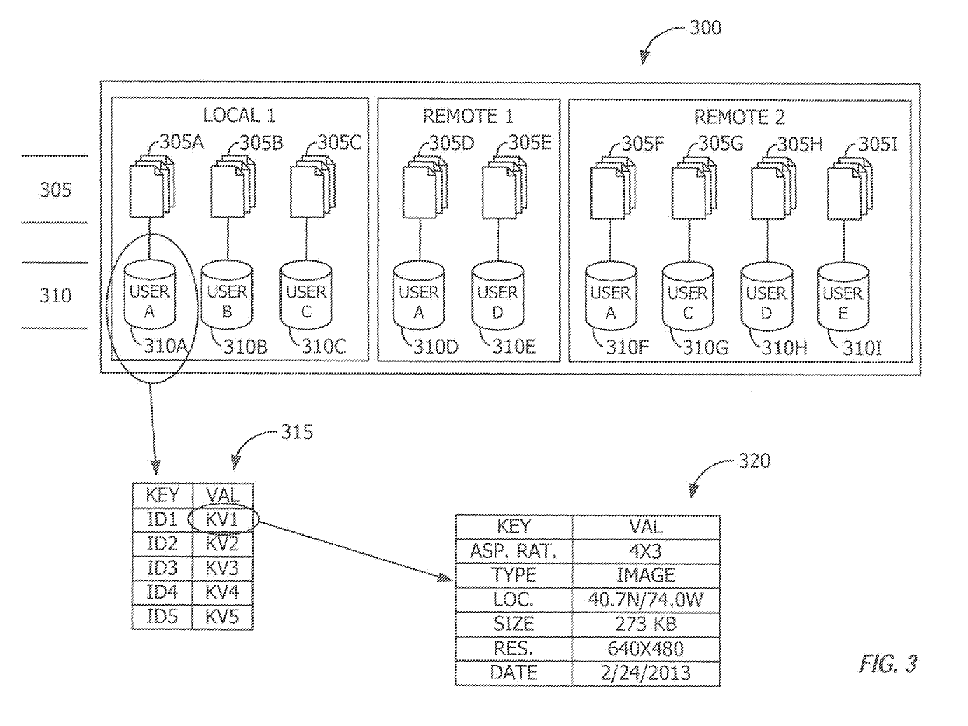

Referring to FIG. 3, the structure of first cache layer 300 is illustrated in accordance with one embodiment. As shown, metadata 310 corresponding to media items 305 are segmented by source and user. For example, user A may have media items 305A stored on a local source, media items 305D stored on a first remote source, and media items 305F stored on a second remote source. Media items 305A, 305D, and 305F may have associated metadata 310A, 310D, and 310F, respectively. Metadata 310A, 310D, and 310F may be segmented from each other in first cache layer 300 such that media items may be quickly browsed and placed in a media arrangement by source. In addition, based on the contemplated people-centered nature of media item presentation, metadata 310A, 310D, and 310F may also be segmented within first cache layer 300 from metadata associated with media items of other users within the same source. For example, metadata 310D and metadata 310E, each associated with media items available from the first remote source, may be segmented based on the association of the metadata with media items corresponding to different users. Accordingly, the structure illustrated in FIG. 3 makes it possible to quickly browse for and present media items from various sources and users. In addition, as will be described in greater detail below, this segmentation methodology may be carried out through other cache layers to provide enhanced granularity in the aggregation of filtered and ordered sets of media items.

In one embodiment, the metadata for each segment may be stored in persistent disk storage as a flat representation of the media item identifiers and associated metadata. In such an embodiment, the cached metadata may be stored as an archived binary plist. Although a database model could be used, this flat representation may be chosen to achieve improved efficiency in identifying a media arrangement and displaying media items in accordance with the identified media arrangement despite the fact that a database model may be more memory friendly. To address potential memory issues, each source may be set to accommodate a predefined number of media item identifiers. In one embodiment, for example, local sources may be setup to accommodate 8192 media items while remote sources may be setup to accommodate 2048 media items. When such a predefined limit is reached, the least recently used media item identifiers may be purged from first cache layer 300 to accommodate new media item identifiers. The least recently used media item identifiers may be determined in a number of different manners. For example, a most recent use of a particular media item identifier may correspond to the display of a media item associated with the media item identifier, the access to metadata associated with the media item identifier (regardless of whether the access results in the display of the associated media item), or any other method of determining the use of the identifier. One of ordinary skill in the art will recognize other cache management algorithms may also be used (e.g., adaptive replacement algorithm).

In the illustrated embodiment, metadata for each individual media item may be stored in a key value store. The key value store for each media item may be accessible through another key value store that lists the media item identifiers for a particular segment. For example, metadata 310 may be accessible through key value stores 315 and 320. Key value store 315 may include keys that are representative of media item identifiers for each relevant media item for the cache segment associated with metadata 310A. The value corresponding to each key in key value store 315 may be a separate key value store 320 having keys representative of the various metadata categories and values corresponding to the metadata values for each category for the media item corresponding to the media item identifier. Therefore, in one embodiment, the metadata for a particular media item in a cache segment may be accessible via a pair of chained key value stores.

In another embodiment, the cached metadata may be stored in a properly indexed database (still per source and per user). Metadata could then be accessed by media item identifier to construct sets and arrays of metadata. In such an embodiment, the database could still be NoSQL based to avoid relation tables and complex queries. The database model may be more appropriate for larger data sets than smaller data sets.

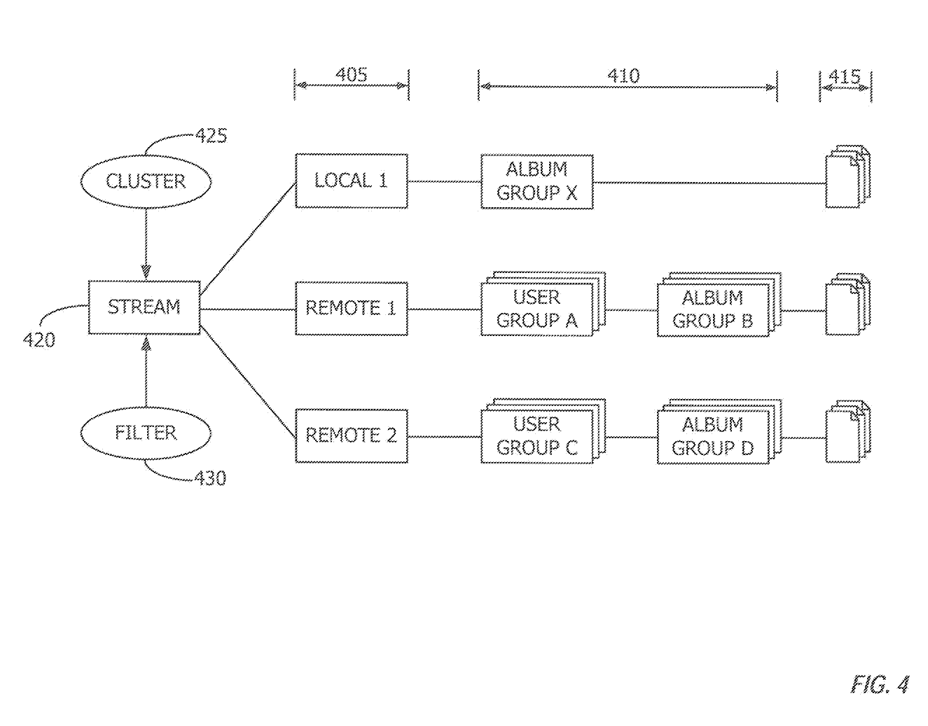

Referring to FIG. 4, the terminology used to describe the abstraction of differences between sources will be introduced. In accordance with one embodiment, a user may browse available media items 415 according to native hierarchical groupings specified by sources 405 and groups 410. Each source 405 may manage user authentication and provide access to source content using source-specific requests. Groups 410 may be described as containers that contain other groups 410 and, ultimately, items 415. For example, a natural media item grouping may be a photo album that includes a number of photos related to a common event or time period or a group of items associated with a particular individual (e.g., a social network friend of a user). Items 415 may represent any type of media item and its corresponding metadata. For example, an image item may include data that represents the image as well as metadata that describes the image. By defining group paths in a manner that abstracts differences between sources, a user may be capable of browsing for media items from various sources using native source grouping. Moreover, based on the abstraction of the differences between sources, media item groupings across multiple sources may be aggregated and presented collectively to a user.

A stream is the aggregator of groups to be presented to a user and may represent a single group path or multiple group paths. For example, a stream based on a request to display all of a user's local media items from “Album X” may be represented by the Uniform Resource Identifier, or URI, set [local 1.X]. Similarly, stream 420 may be represented by the URI set [local 1.X, remote 1.A.B, remote 2.C.D]. As can be seen, the group paths abstract differences between the arrangement of media items across different sources and maintain the ability to browse for media items using native source groupings and the aggregator enables media items from multiple group paths to be combined consistently into a stream. As will be described in greater detail below, in one embodiment a stream may define an unordered set of media items.

In one embodiment, two different types of presenters may be utilized to alter the manner in which media content of a stream is presented to a user. A filter may be utilized to modify the content of a stream that is presented based on specific filter criteria. For example, filter 430 may result in the selection of only those media items from stream 420 that are associated with a specified filter condition such as a time period and/or location and may order the media items satisfying the filter conditions according to an ordering technique. The media items presented based on a filter may either include the entire content of the stream (when all media items comply with the filter criteria) or may be subset of the content. A cluster may be to order the media items in a stream without applying a filter condition. For example, cluster 425 may result in the chronological or importance-based ordering of media items within stream 420. Clustering generally results in a set of clusters where each cluster represents a specific parameter value based on the given clustering criteria. For example, if the clustering criteria is location, clustering the stream may result in having three different clusters each of which includes media items having a specific location (e.g. one cluster for San Francisco, one for Paris, and one for Tokyo).

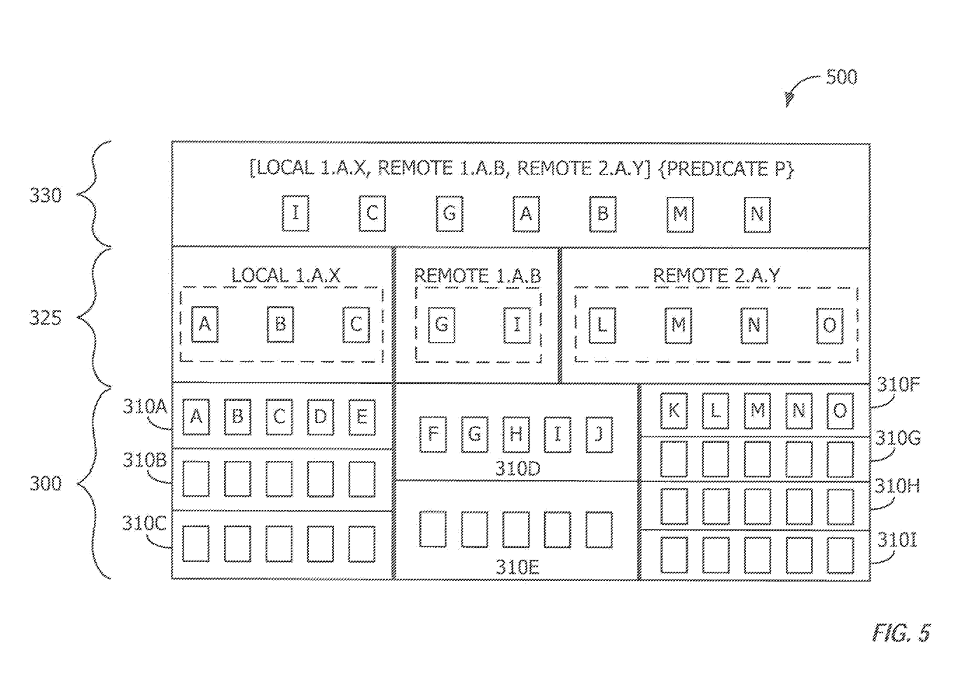

With this terminology in mind and referring to FIG. 5, a layered cache structure may be described in accordance with one embodiment of the disclosure. Persistent disk cache 500 may include multiple cache layers 300, 325, and 330. As described above, first cache layer 300 may include a flat representation of the media item metadata for all available media items segmented by source and user.

First cache layer 300 may be updated, for example, in accordance with cache update operation 200. As described above, cache update operations may begin with a media item initialization request that causes the media arrangement application to query one or more sources to retrieve a list of media item identifiers corresponding to the requested grouping. For example, the media arrangement application may query the first local source for a list of media item identifiers that identify all of the media items associated with user A's photo album X in response to a user browsing this photo album. Upon receiving the list of media item identifiers associated with the desired group path (i.e., local 1.A.X), the application may update first cache layer 300 as described in operation 200. The metadata associated with media items in first cache layer 300 may be segmented by source and by user. In the illustrated embodiment, metadata 310A includes multiple key value stores (labeled A through E) corresponding to the media items associated with user A and available through local source 1.

In addition to the operations described in cache update operation 200, in response to a user browsing the media items for a particular group path, the metadata corresponding to the media items for the browsed group path may be stored in second cache layer 325. Like the metadata in first cache layer 300, the metadata in second cache layer 325 may be segmented by source and by user. In addition, the metadata in second cache layer may be segmented by group. For example, the metadata corresponding to user A's photo album X in local source 1 metadata for media items A, B, and C) may be stored in second cache layer 325 and associated with group path [local 1.A.X]. Similarly, the metadata corresponding to user A's photo album B in remote source 1 (i.e., metadata for media items G and I-[remote 1.A.B]) and photo album Y in remote source 2 (i.e., metadata for media items L, M, N, and O-[remote 2.A.Y]) may also be stored in second cache layer 325. As described above, first cache layer 300 may be implemented as a key value store of key value stores, segmented per source and per user. That is, for each source and user, a first key value store may include keys corresponding to each of the media items associated with the source and user and corresponding values that are second key value stores that include metadata for the media items. In one embodiment, second cache layer 325 may store the second key value stores (i.e., the key value stores that include the metadata) for a particular grouping of media items. Each particular grouping in second cache layer 325 may be stored as an unordered set of key value stores. While second cache layer 325 provides an additional layer of granularity with respect to first cache layer 300 in that it allows for the storage of metadata for media items corresponding to particular media item groups, the metadata corresponding to one or more second cache layer groups may need to be aggregated, filtered, and/or ordered before the media items can be fit to a media arrangement.

The results of the aggregating, filtering, and ordering operation may produce an ordered array of metadata items. These ordered arrays may be stored in third cache layer 330, which provides an additional layer of granularity. In the illustrated embodiment, a user may select to view media items from user A's photo albums X, B, and Y, from the local 1, remote 1, and remote 2 sources, respectively. In addition, the user may desire to display only the media items from those groups that satisfy a particular filter condition and to display the items according to a certain order. These filtering and ordering conditions may be defined as a predicate to be applied to the aggregated groups of metadata (e.g., predicate P). For example, the user may want to view all of the items from the selected photo albums that were taken within a certain time period or within a certain geographical area. In response to such a request, a media arrangement application may gather metadata for the specified groups from second cache layer 325, evaluate the metadata to identify the media items that satisfy the filter condition, and order the metadata for the media items that satisfy the filter condition according to ordering criteria (e.g., chronologically, according to an importance measure, etc.). The resulting array of metadata items that satisfy the filter condition may then be stored in third cache layer 330 and associated with the group paths and filter conditions that resulted in the array (e.g., [local 1.A.X, remote 1.A.B, remote 2.A.Y] {predicate P}). The arrays of metadata items in third cache layer 330 may be accessed upon a subsequent request to display the same group of media items with the same filtering and ordering conditions without performing any additional filtering, ordering, or aggregating operations.

In one embodiment, second and third cache layers 325 and 330 may be structured as least recently used caches in a similar manner as first cache layer 300. For example, a predefined limit on the number of metadata items in each of the second and third cache layers 325 and 330 may be established and the least recently used metadata groupings may be deleted if an operation will result in the predefined limit being exceeded. As previously noted, one of ordinary skill in the art will appreciate other cache management algorithms may be used.

The described multi-layer cache system minimizes the number of requests that need to be submitted to a source in order to display a desired group of media items. This can improve the user experience as it minimizes the lag time between a request to display media items and the display of those media items. Example third cache layer 330 maintains final ordered arrays of metadata that enable media items to be fit to a media arrangement without any further information retrieval or filtering operations. Example second cache layer 325 maintains metadata in accordance with source groupings such that, once obtained a first time, the media items corresponding to a particular grouping need not be repeatedly requested from a source. Example first cache layer 300 maintains media item metadata segmented by source and by user such that only metadata for newly added media items (i.e., added since a last media item initialization request) needs to be requested from a source when it is desired to display media items corresponding to a particular media item grouping.

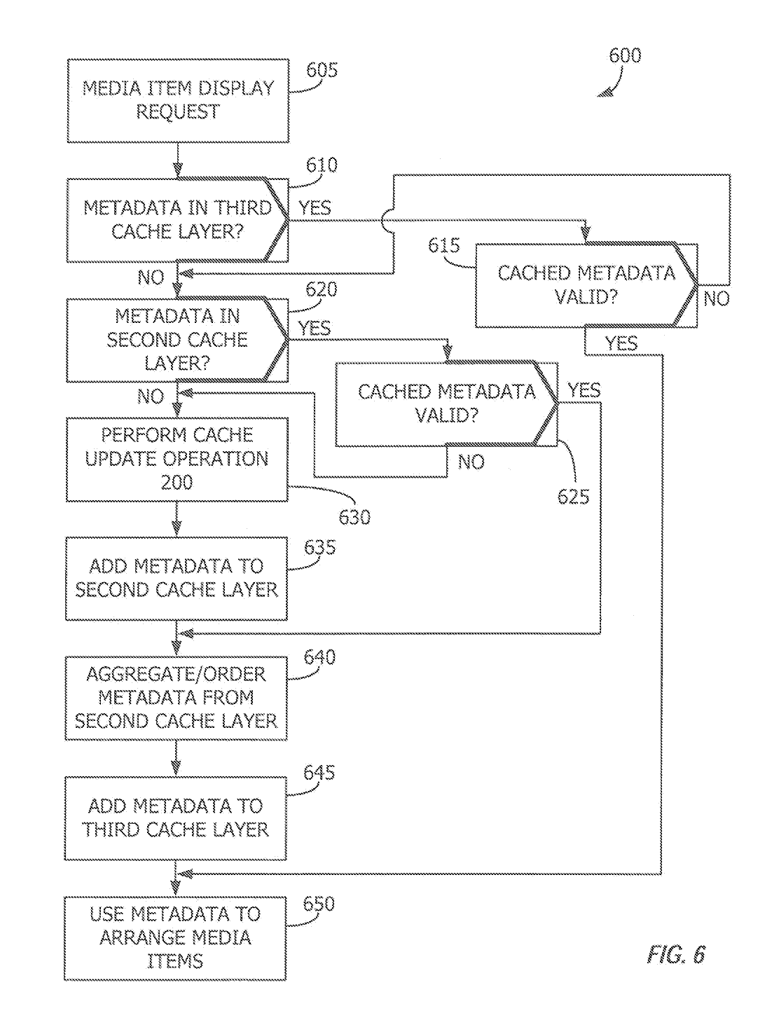

Referring to FIG. 6, media arrangement operation 600 illustrates the utilization of metadata in the various cache layers to determine an appropriate media arrangement for a group of media items. Media arrangement operation 600 may begin with a request to display media items (block 605). The request may identify media items associated with one or more users (e.g., uploaded to a particular source by one or more users) and available from one or more sources. In one embodiment, the request may be initiated when a user browses through media item groupings for one or more connected sources. In another embodiment, the request may be initiated in response to a user request for media items corresponding to a specified criteria set (e.g., all of user A's photographs taken in New York City in July 2012). In yet another embodiment, the request may be initiated by another application (i.e., separate from an application that provides one or more operations in accordance with this disclosure). Regardless of the specific form of the request, it may be determined if the metadata associated with the request is available in the third cache layer (block 610). As described above, the third cache layer may include an ordered array of metadata for a specified group of media items. Because the third layer cache may identify media item groupings by group path and applied predicate, it may quickly be determined if the media request corresponds to a group of media items having stored metadata within the third cache layer. For example, if the user request is initiated by a user browsing connected sources, it may be determined if an array of metadata associated with the browsed group path (and any filter condition associated with the request) is available in the third cache layer. If the request identifies all media items meeting a specified set of criteria (e.g., all of user A's photographs taken in New York City in July 2015), it may be determined if an array of metadata associated with a set of group paths and filter conditions that would satisfy the request is available in the third cache layer.

If it is determined that metadata corresponding to the request is stored in the third cache layer (the “Yes” prong of block 610), it may then be determined if the cached metadata is valid. The evaluation of the validity of cached metadata ensures that an up-to-date and accurate set of media items are displayed for a cached grouping. Metadata stored in the second and third cache layers (because they represent media item groupings) may be invalidated based on the occurrence of certain events such that the most up to date information must be retrieved from a lower level cache layer or from the source itself. Events that may cause the invalidation of metadata in the second or third cache layers include, but are not limited to, discontinuing use of the media arrangement application (e.g., an application that executes operation 600), occurrence of an authorization or authentication error for a source associated with the cached metadata, change in network connectivity for a remote source main access point for a source associated with the cached metadata, detection of a live update of media items for a source associated with the cached metadata, or an update to lower level metadata associated with the cached metadata (e.g., an update to include metadata in addition to placement metadata, detection of region of interest by background process, etc.). Additional cached metadata invalidation events may be determined based on the specific details of an actual implementation.

In one embodiment, a list of invalidation events may be stored and cached metadata may be compared against the invalidation events to determine the validity of the cached metadata upon retrieval (i.e., validity of cached metadata may be determined immediately prior to the usage of the cached metadata to determine a media arrangement). In another embodiment, upon the occurrence of an invalidation event, the cache system may be evaluated such that any metadata that is invalidated by the detected event can be removed from the cache or flagged as invalid (e.g., the validity of cached metadata may be determined at the time of the invalidation event). In yet another embodiment, a combination of these two techniques may be used. For example, certain invalidation events (such as the user exiting the media arrangement application) may cause the metadata in the second and third cache layers to be deleted/flagged as invalid at the time of the event while other invalidation events (such as the detection of a live update of media items associated with a connected source) may be maintained in a list and evaluated against a particular set of cached metadata at the time of the cached metadata's usage to determine the relevance of the invalidation event.

Regardless of the manner in which the validity of cached metadata is evaluated, if it is determined that valid cached metadata exists in the third cache layer (the “Yes” prongs of blocks 610 and 615), the cached metadata may be used to identify an arrangement for media items corresponding to the media request (block 650). If, however, it is determined that no valid cached metadata corresponding to the media request is available (the “No” prong of block 610 or 615), it may be determined whether metadata corresponding to the media request is available in the second cache layer (block 620). While the high level cache layer (e.g., the third cache layer) contains ordered metadata for specified aggregated groups of media items across multiple group paths, the lower level caches (e.g., the first and second cache layers) are segmented. Accordingly, operations 620 through 645 may be performed per group path. It is in this regard that the granularity of the disclosed multi-layer cache system is beneficial. For example, a media request may include a request for media items from multiple different sources and users. The cached metadata for the media items corresponding to the request may vary. For example, second layer cached metadata may exist for some group paths, metadata may exist in the first cache layer for all of the media items for other group paths, metadata may exist in the first cache layer for a portion of the media items for other group paths, and metadata may not exist for any media items in any cache layer for still other group paths.

If it is determined that metadata exists in the second cache layer for one or more group paths associated with the media request (the “Yes” prong of block 620), the validity of the cached metadata may be evaluated in a manner similar to the evaluation of the third cache layer metadata described above (block 625). If the cached metadata is valid (the “Yes” prong of block 625), the metadata may be aggregated with other second cache layer metadata (if other metadata is required based on the request) as described below.

If it is determined that no valid second layer cached metadata exists for one or more group paths associated with the media request (the “No” prong of block 620 or 625), cache update operation 200 may be performed for those group paths. As noted above with respect to FIG. 2, a media item initialization request may seek to identify all of the media item identifiers associated with the group path. For each group path, all, some, or none of the metadata for the media items may be present in the first cache layer. If metadata needs to be retrieved from the source for any media items for a particular group path, the placement metadata may be retrieved first. While cache update operation 200 may continue to obtain additional metadata from the source, once the placement metadata is available for each of the media items for a group path, the available metadata may be added to the second cache layer. After at least the placement metadata for each group path associated with the request and not having second cache layer metadata is added to the second cache layer, the second cache layer metadata for each of the group paths (including the previously identified group paths having valid second cache layer metadata) associated with the request may be aggregated, ordered, and filtered (block 640). As described above, the second cache layer may include unordered sets of metadata that may be segmented by source, user, and group. The filtering operation may include searching through the second layer metadata to exclude the metadata items that do not satisfy one or more filter criteria. The aggregation operation may include combining the metadata from all of the group paths associated with the media request (if multiple paths are associated with the request). The ordering operation may include utilizing the second layer metadata to order the metadata items according to one or more specified ordering criteria. The filtered, aggregated, and ordered metadata corresponding to the media request may then be added to the third cache layer (block 645). In one embodiment, the third cache layer metadata may be structured as an array of key value stores. In one embodiment, the metadata corresponding to the media request in the third cache layer may include an identifier that allows the media item grouping represented by the cached metadata to be determined. For example, the identifier may specify the group paths associated with the metadata and any applied filtering and ordering criteria. The third layer cached metadata corresponding to the media request may then be utilized to identify a media arrangement according to which the media items corresponding to the media request may be presented (block 650).

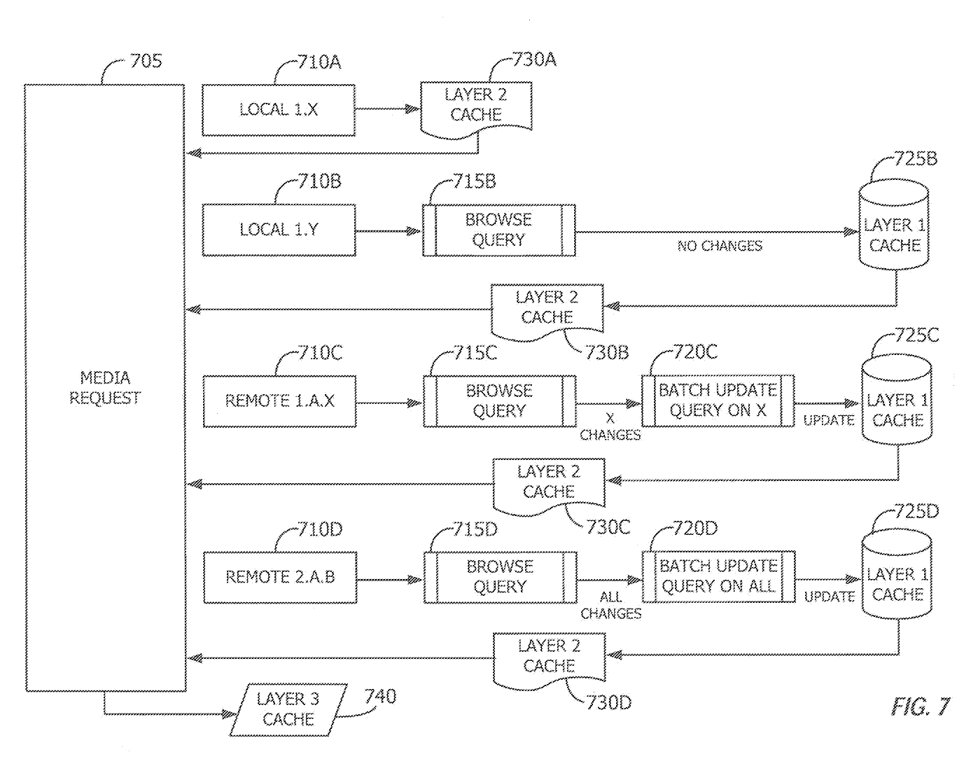

Referring to FIG. 7, some beneficial effects of the granularity of the multi-layer cache approach are illustrated through media request 705 for media items that span across multiple sources and group paths. In the illustrated embodiment, media request 705 requires the aggregation of media items from group paths 710A, 710B, 710C, and 710D. For example, media request 705 may seek to display all of the media items associated with a certain user and it may be determined that the four group paths 710A-710D are associated with the user. In response to the request, metadata that is needed to identify an appropriate media arrangement for the media items corresponding to media request 705 may be retrieved in a separate thread for each group path. As illustrated in FIG. 7, the separation of processing by group path may allow the different metadata requirements for each group path to be handled naturally.

For example, valid metadata corresponding to group path 710A may be stored in second cache layer segment 730A. For each of the other group paths, it may be determined that no valid second cache layer metadata exists. Consequently, cache update operation 200 may be performed for each of group paths 710B, 710C, and 710D. For these group paths, browse queries 715B, 715C, and 715D (e.g., media item initialization requests) may be submitted to each of the respective sources to retrieve a list of media item identifiers corresponding to the media items for the specified group path. For group path 710B, browse query 715B may result in the identification of a set of media item identifiers that each correspond to a media item identifier having associated metadata in first cache layer segment 725B. Because all of the metadata for group path 710B is stored in first cache layer segment 725B, no additional metadata is needed from the local 1 source. Metadata corresponding to the media items in group path 710B may be retrieved from first cache layer segment 725B and stored in second cache layer segment 730B.

For group path 710C, browse query 715C may result in the identification of a set of media item identifiers that include a certain number of identifiers (e.g., X identifiers) for which no metadata exists in first cache layer segment 725C. In response, batch update query 720C (which may be implemented as a set of queries) may be submitted to the remote 1 source to retrieve metadata associated with the identifiers for which no metadata currently exists in cache (e.g., the X identifiers). When placement metadata has been retrieved for these identifiers, it may be used to update first cache layer segment 725C and the metadata corresponding to the media items in group path 710C (now available through first cache layer segment 725C) may be stored in second cache layer segment 730C.

For group path 710D, browse query 715D may result in the identification of a set of media item identifiers for which no corresponding metadata is available for any of the media item identifiers. For example, group path 710D may represent a photo album that includes media items that were recently uploaded to the remote 2 source and that have not yet been retrieved through the media arrangement application. In response, batch update query 720D (which may be implemented as a set of queries) may be submitted to the remote 2 source to retrieve metadata for each of the media items corresponding to group path 710D. When the placement metadata for each of the media items in group path 710D has been retrieved, it may be used to update first cache layer segment 725D and the metadata corresponding to the media items in group path 710D (now available through first cache layer segment 725D) may be stored in second cache layer segment 730D.

The second cache layer metadata corresponding to each of the group paths invoked by media request 705 can then be aggregated, filtered, and ordered according to any criteria associated with media request 705. The ordered array of metadata corresponding directly to media request 705 can then be stored in third cache layer segment 740 and associated with an identifier of media request 705 (e.g., [local 1.X, local 1.Y, remote 1.A.X, remote 2.A.Y]). For as long as third cache layer segment 740 is valid, any subsequent media request 705 will result in the simple retrieval of the ordered metadata from third cache layer segment 740 without performing any of the lower layer cache or source query operations. As can be seen in FIG. 7, the multi-layer cache approach allows for the efficient handling of media items across multiple sources and different metadata cache states.

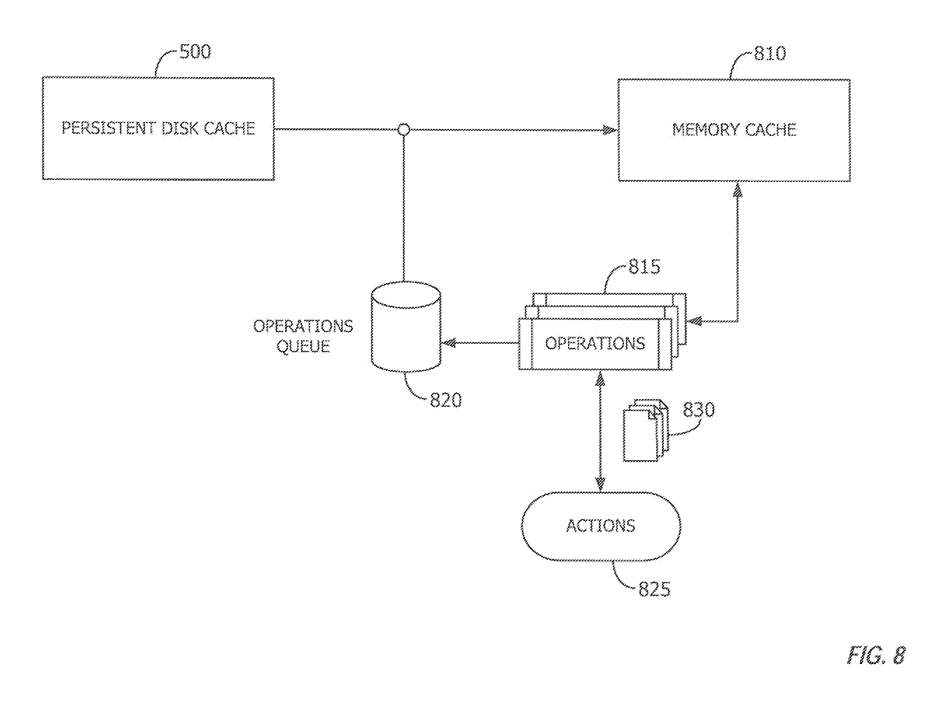

Referring to FIG. 8, in accordance with one embodiment, metadata from persistent disk cache 500 may be loaded into memory cache 810 on demand. In one embodiment, the architecture illustrated in FIG. 8 may be implemented on a per connected source basis. For example, just as persistent disk cache 500 can be segmented per source, memory cache 810 may be segmented likewise such that the architecture illustrated in FIG. 8 may be viewed as the persistent storage and memory for a single source. Like persistent disk cache 500, memory cache 810 may be administered as a least recent used cache. That is, after metadata is loaded into memory 810, the metadata may be dumped back to disk cache 500 upon memory pressure and in accordance with memory cleanup protocols. For example, if metadata corresponding to a certain group path has not been accessed from memory 810 for 30 seconds, the metadata may be dropped from memory 810. In operation, one or more actions 825 such as a media request or browsing through a particular source hierarchy may result in the performance of one or more operations 815. Operations 815 may be queued in operations queue 820, and, upon execution of a particular operation, metadata corresponding to the operation may be retrieved from persistent disk cache 500 and loaded into memory 810. All operations 815 may concurrently access memory 810.

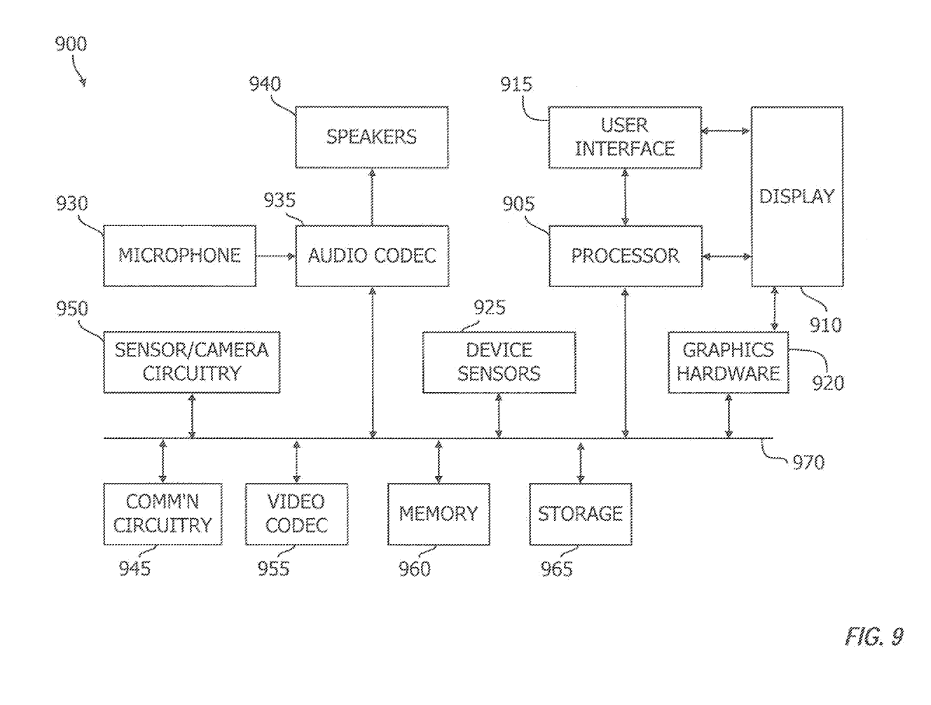

Referring to FIG. 9, a simplified functional block diagram of illustrative electronic device 900 is shown according to one embodiment. Electronic device 900 may include processor 905, display 910, user interface 915, graphics hardware 920, device sensors 925 (e.g., proximity sensor/ambient light sensor, accelerometer and/or gyroscope), microphone 930, audio codec(s) 935, speaker(s) 940, communications circuitry 945, digital image capture unit 950, video codec(s) 955, memory 960, storage 965, and communications bus 970. Electronic device 900 may be, for example, a digital camera, a personal digital assistant (PDA), personal music player, mobile telephone, server, notebook, laptop, desktop, or tablet computer. More particularly, the disclosed techniques may be executed on a device that includes some or all of the components of device 900.

Processor 905 may execute instructions necessary to carry out or control the operation of many functions performed by device 900. Processor 905 may, for instance, drive display 910 and receive user input from user interface 915. User interface 915 can take a variety of forms, such as a button, keypad, dial, a click wheel, keyboard, display screen and/or a touch screen. Processor 905 may also, for example, be a system-on-chip such as those found in mobile devices and include a dedicated graphics processing unit (GPU). Processor 905 may be based on reduced instruction-set computer (RISC) or complex instruction-set computer (CISC) architectures or any other suitable architecture and may include one or more processing cores. Graphics hardware 920 may be special purpose computational hardware for processing graphics and/or assisting processor 905 to process graphics information. In one embodiment, graphics hardware 920 may include a programmable graphics processing unit (GPU).

Sensor and camera circuitry 950 may capture still and video images that may be processed, at least in part, in accordance with the disclosed techniques by video codec(s) 955 and/or processor 905 and/or graphics hardware 920, and/or a dedicated image processing unit incorporated within circuitry 950. Images so captured may be stored in memory 960 and/or storage 965. Memory 960 may include one or more different types of media used by processor 905 and graphics hardware 920 to perform device functions. For example, memory 960 may include memory cache 810, read-only memory (ROM), and/or random access memory (RAM). Storage 965 may store media (e.g., audio, image and video files), computer program instructions or software, preference information, device profile information, and any other suitable data. Storage 965 may include one or more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Persistent disk cache 500 may be maintained within at least a portion of storage 965. Memory 960 and storage 965 may also be used to tangibly retain computer program instructions or code organized into one or more modules and written in any desired computer programming language. When executed by, for example, processor 905 such computer program code may implement one or more of the operations described herein.

It is to be understood that the above description is intended to be illustrative, and not restrictive. The material has been presented to enable any person skilled in the art to make and use the inventive concepts described herein, and is provided in the context of particular embodiments, variations of which will be readily apparent to those skilled in the art. For example, some of the disclosed embodiments may be used in combination with each other. As another example, an implemented cache structure may use more than three (3) layers. Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A non-transitory program storage device, readable by a processor and comprising instructions stored thereon to cause one or more processors to:
receive a media request;
determine whether an ordered set of metadata items corresponding to the request is stored in a high level cache layer in persistent storage;
retrieve the ordered set of metadata items from the high level cache layer when it is determined that the ordered set of metadata items is stored in the high level cache layer;
construct an ordered set of metadata items corresponding to the request from other metadata items in one or more lower level cache layers in persistent storage when it is determined that the ordered set of metadata items is not stored in the high level cache layer; and
use the retrieved or constructed ordered set of metadata items to identify a media arrangement in which to display one or more media items corresponding to the request.

2. The non-transitory program storage device of claim 1, wherein the instructions to cause the one or more processors to receive a media request comprise instructions to cause the one or more processors to receive a request to display a plurality of media items associated with a plurality of users and from a plurality of media sources.

3. The non-transitory program storage device of claim 1, wherein the instructions to cause the one or more processors to determine whether an ordered set of metadata items corresponding to the request is stored in a high level cache layer comprise instructions to cause the one or more processors to identify one or more media item groupings that correspond to the request.

4. The non-transitory program storage device of claim 3, wherein the one or more media item groupings are specified by group paths that identify a source and a native hierarchical grouping level at the source for media items in the media item grouping.

5. The non-transitory program storage device of claim 3, wherein the instructions to cause the one or more processors to determine whether an ordered set of metadata items corresponding to the request is stored in a high level cache layer comprise instructions to cause the one or more processors to identify a predicate to be applied to the one or more media item groupings.

6. The non-transitory program storage device of claim 5, wherein the instructions to cause the one or more processors to determine whether an ordered set of metadata items corresponding to the request is stored in a high level cache layer comprise instructions to cause the one or more processors to determine whether an ordered set of metadata items in the high level cache layer includes an identifier corresponding to the one or more media item groupings and the predicate.

7. The non-transitory program storage device of claim 1, wherein the instructions to cause the one or more processors to construct an ordered set of metadata items corresponding to the request from other metadata items in one or more lower level cache layers comprise instructions to cause the one or more processors to retrieve metadata items from one or both of a first lower level cache layer and a second lower level cache layer.

8. The non-transitory program storage device of claim 7, wherein the first lower level cache layer comprises metadata items that are segmented by user and by source.

9. The non-transitory program storage device of claim 7, wherein the second lower level cache layer comprises metadata items that are segmented by user, source, and media item grouping.

10. The non-transitory program storage device of claim 7, wherein the instructions to cause the one or more processors to construct an ordered set of metadata items corresponding to the request from other metadata items in one or more lower level cache layers comprise instructions to cause the one or more processors to:
determine whether a set of metadata items corresponding to each of one or more media item groupings associated with the request is stored in the second lower level cache layer; and
construct a set of metadata items corresponding to the media item grouping when it is determined that the set of metadata items is not stored in the second lower level cache layer.

11. The non-transitory program storage device of claim 10, wherein the instructions to cause the one or more processors to determine whether the set of metadata items is stored in the second lower level cache layer and to construct the set of metadata items are executed in a separate thread for each of the one or more media item groupings.

12. The non-transitory program storage device of claim 10, wherein the instructions to cause the one or more processors to construct a set of metadata items corresponding to the media item grouping comprise instructions to cause the one or more processors to:
query a source associated with the media item grouping to retrieve media item identifiers for media items in the media item grouping;
determine whether metadata is stored in the first lower level cache layer for all of the media items in the media item grouping based, at least in part, on the retrieved media item identifiers;
query the source associated with the media item grouping to retrieve metadata corresponding to media item identifiers in the retrieved media item identifiers and having no corresponding metadata in the first lower level cache layer; and
construct the set of metadata items for the media item grouping using the stored metadata and the retrieved metadata.

13. The non-transitory program storage device of claim 12, wherein the instructions to cause the one or more processors to construct a set of metadata items corresponding to the media item grouping further comprise instructions to cause the one or more processors to store the constructed set of metadata items in the second lower level cache layer.

14. The non-transitory program storage device of claim 7, wherein each of the metadata items comprises a key value store.

15. The non-transitory program storage device of claim 14, wherein each key value store in the first lower level cache layer is accessible via another key value store.

16. The non-transitory program storage device of claim 14, wherein the instructions to cause the one or more processors to construct an ordered set of metadata items corresponding to the request comprise instructions to cause the one or more processors to construct an array of key value stores.

17. The non-transitory program storage device of claim 1, further comprising instructions to cause the one or more processors to store the constructed ordered set of metadata items in the high level cache layer.

18. A device, comprising:
a memory;
a display device; and
one or more processors operatively coupled to the memory and the display device, the one or more processors configured to execute program code stored in the memory to:
receive a request to display a plurality of media items;
determine whether an ordered set of metadata items corresponding to the request is stored in a high level cache layer in the memory;
retrieve the ordered set of metadata items from the high level cache layer when it is determined that the ordered set of metadata items is stored in the high level cache layer;
construct an ordered set of metadata items corresponding to the request from other metadata items in one or more lower level cache layers in the memory when it is determined that the ordered set of metadata items is not stored in the high level cache layer; and
display, on the display device, the plurality of media items in a media arrangement identified based, at least in part, on the ordered set of metadata items.

19. The device of claim 18, further comprising an image capture device.

20. The device of claim 19, wherein one or more of the plurality of media items comprises a digital image captured by the image capture device.

21. The device of claim 18, wherein the program code to cause the one or more processors to construct an ordered set of metadata items corresponding to the request from other metadata items in one or more lower level cache layers comprises program code to cause the one or more processors to:
determine whether a set of metadata items corresponding to each of one or more media item groupings associated with the request is stored in a second lower level cache layer; and
construct a set of metadata items corresponding to the media item grouping from metadata items in a first lower level cache layer when it is determined that the set of metadata items is not stored in the second lower level cache layer.

22. The device of claim 21, wherein the program code to cause the one or more processors to construct a set of metadata items corresponding to the media item grouping comprises program code to cause the one or more processors to:
query a source associated with the media item grouping to retrieve media item identifiers for media items in the media item grouping;
determine whether metadata is stored in the first lower level cache layer for all of the media items in the media item grouping based, at least in part, on the retrieved media item identifiers;
query the source associated with the media item grouping to retrieve metadata corresponding to media item identifiers in the retrieved media item identifiers and having no corresponding metadata in the first lower level cache layer; and
construct the set of metadata items for the media item grouping using one or both of the stored metadata and the retrieved metadata.

23. The device of claim 22, further comprising program code stored in the memory to cause the one or more processors to:
determine whether an addition of a metadata item associated with a first source to the first lower level cache layer will result in a number of metadata items associated with the first source that exceeds a threshold; and
delete a least recently used metadata item associated with the first source from the first lower level cache layer when it is determined that the addition of the metadata item will result in a number of metadata items that exceeds the threshold.

24. A method, comprising:
receiving, using one or more processors, a request to display a plurality of media items;
identifying, using the one or more processors, one or more media item groupings associated with the request;
determining, using the one or more processors, whether an ordered array of metadata items for the one or more media item groupings is stored in a high level cache layer, wherein the ordered array of metadata items is used to match the plurality of media items with one or more media item arrangements;
retrieving, using the one or more processors, the ordered array of metadata items from the high level cache layer when it is determined that the ordered array of metadata items is stored in the high level cache layer;
constructing, using the one or more processors, the ordered array of metadata items when it is determined that the ordered array of metadata items is not stored in the high level cache layer, wherein constructing the ordered array of metadata items comprises:
determining, using the one or more processors, whether a set of metadata items corresponding to each of the one or more media item groupings is stored in a second lower level cache layer; and
constructing, using the one or more processors, a set of metadata items corresponding to the media item grouping from metadata items in a first lower level cache layer when it is determined that the set of metadata items is not stored in the second lower level cache layer.

25. The method of claim 24, wherein the act of constructing a set of metadata items corresponding to the media item grouping comprises:
querying, using the one or more processors, a source associated with the media item grouping to retrieve a list of media item identifiers for the media item grouping;
determining, using the one or more processors, whether metadata is stored in the first lower level cache layer for each of the media item identifiers in the list;
querying, using the one or more processors, the source associated with the media item grouping to retrieve metadata for the listed media item identifiers that do not have metadata stored in the first lower level cache layer; and
constructing, using the one or more processors, the set of metadata items for the media item grouping using one or both of the stored metadata and the retrieved metadata.

26. The method of claim 24, wherein the act of constructing a set of metadata items corresponding to the media item grouping further comprises storing the constructed set of metadata items in the second lower level cache layer.
